(19) United States
(12) Patent Application Publication
(10) Pub. No.: US 2026/0039208 A1
(43) Pub. Date: Feb. 5, 2026

(54) CURRENT SENSING IN A POWER CONVERTER

(71) Applicant: TEXAS INSTRUMENTS INCORPORATED, Dallas, TX (US)

(72) Inventors: Akhila Gundavarapu, Bangalore (IN); Suvadip Banerjee, Bangalore (IN); Michael Lueders, Freising (DE)

(21) Appl. No.: 18/951,954

(22) Filed: Nov. 19, 2024

Related U.S. Application Data
(60) Provisional application No. 63/678,567, filed on Aug. 2, 2024.

(51) Int. Cl. H02M 3/335; H02M 1/00

(52) U.S. Cl. CPC H02M 3/33569; H02M 1/0009; H02M 1/0083

(57) ABSTRACT

An apparatus includes a switch circuit, first through fourth transistors, and a comparator. The switch circuit has first and second terminals. The first transistor has first and second terminals and a control terminal. The second terminal is coupled to the second terminal of the switch circuit. The second transistor has first and second terminals and a control terminal. The control terminals of the first and second transistors are coupled together. The third transistor has first and second terminals and a control terminal. The fourth transistor has first and second terminals and a control terminal. The control terminals of the third and fourth transistors are coupled together, and the first terminals of the first, second, third, and fourth transistors are coupled together. The comparator has first and second comparator inputs. The first comparator input is coupled to the second terminals of the second and fourth transistors.

### CROSS-REFERENCE TO RELATED APPLICATIONS

This application claims priority to U.S. Provisional Application No. 63/678,567, filed Aug. 2, 2024 and titled “Aging Invariant Reliable Current Sensing in GAN,” which is hereby incorporated by reference.

### BACKGROUND

Some power converters include high electron mobility transistors. Examples of high electron mobility transistors include gallium nitride (GaN) transistors, aluminum gallium nitride (AlGaN) transistors, indium phosphide (InP) transistors, silicon carbide (SiC) transistors, etc. A GaN transistor, for example, has advantages, such as lower conduction and switching losses, over silicon-based transistors, but repeatedly switching on and off a GaN transistor with a relatively high drain-to-source voltage (Vds) can cause stress the GaN transistor in which the on-resistance of the transistor increases with age.

### SUMMARY

In one example, an apparatus includes a switch circuit, first through fourth transistors, and a comparator. The switch circuit has first and second terminals. The first transistor has first and second terminals and a control terminal. The second terminal is coupled to the second terminal of the switch circuit. The second transistor has first and second terminals and a control terminal. The control terminals of the first and second transistors are coupled together. The third transistor has first and second terminals and a control terminal. The fourth transistor has first and second terminals and a control terminal. The control terminals of the third and fourth transistors are coupled together, and the first terminals of the first, second, third, and fourth transistors are coupled together. The comparator has first and second comparator inputs. The first comparator input is coupled to the second terminals of the second and fourth transistors.

In another example, an apparatus includes a switch circuit having first and second switch terminals. A first transistor has first and second terminals and a control terminal. The second terminal is coupled to the second switch terminal of the switch circuit. A second transistor has first and second terminals and a control terminal with the control terminals of the first and second transistors coupled together. A third transistor has first and second terminals and a control terminal. A fourth transistor has first and second terminals and a control terminal. The control terminals of the third and fourth transistors are coupled together. A transformer has a primary coil and a secondary coil. The first terminals of the first, second, third, and fourth transistors are coupled to the primary coil.

In yet another example, an apparatus includes a switch circuit having a first and second control terminals and first and second switch terminals. A first transistor has first and second terminals and a control terminal. The second terminal is coupled to the second switch terminal of the switch circuit. A second transistor has first and second terminals and a control terminal. The control terminals of the first and second transistors are coupled together. A third transistor has first and second terminals and a control terminal. A fourth transistor has first and second terminals and a control terminal. The control terminals of the third and fourth transistors are coupled together. A comparator has first and second comparator inputs and an output. The first comparator input is coupled to the second terminals of the second and fourth transistors. A control circuit has a first input, a second input, a first output, a second output, and a third output. The first input of the control circuit is coupled the output of the comparator. The second input of the control circuit is coupled to the first terminals of the first, second, third, and fourth transistors. The first output of the control circuit is coupled to the first control terminal of the switch circuit. The second output of the control circuit is coupled to the control terminals of the third and fourth transistors and to the second control terminal of the switch circuit

### BRIEF DESCRIPTION OF THE DRAWINGS

FIG. 1 is a schematic diagram of a power converter, in an example.

FIG. 1 is a schematic diagram of a power converter, in another example.

FIG. 3 is a schematic diagram of a power converter, in yet an example.

### DETAILED DESCRIPTION

The same reference numbers or other reference designators are used in the drawings to designate the same or similar (either by function and/or structure) features.

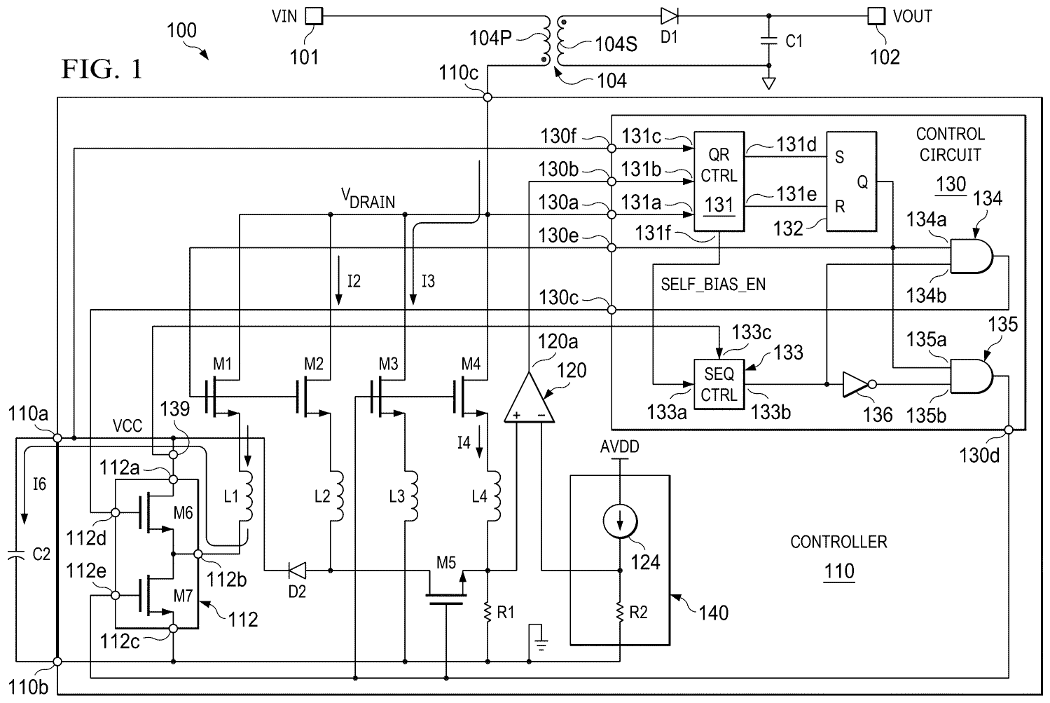

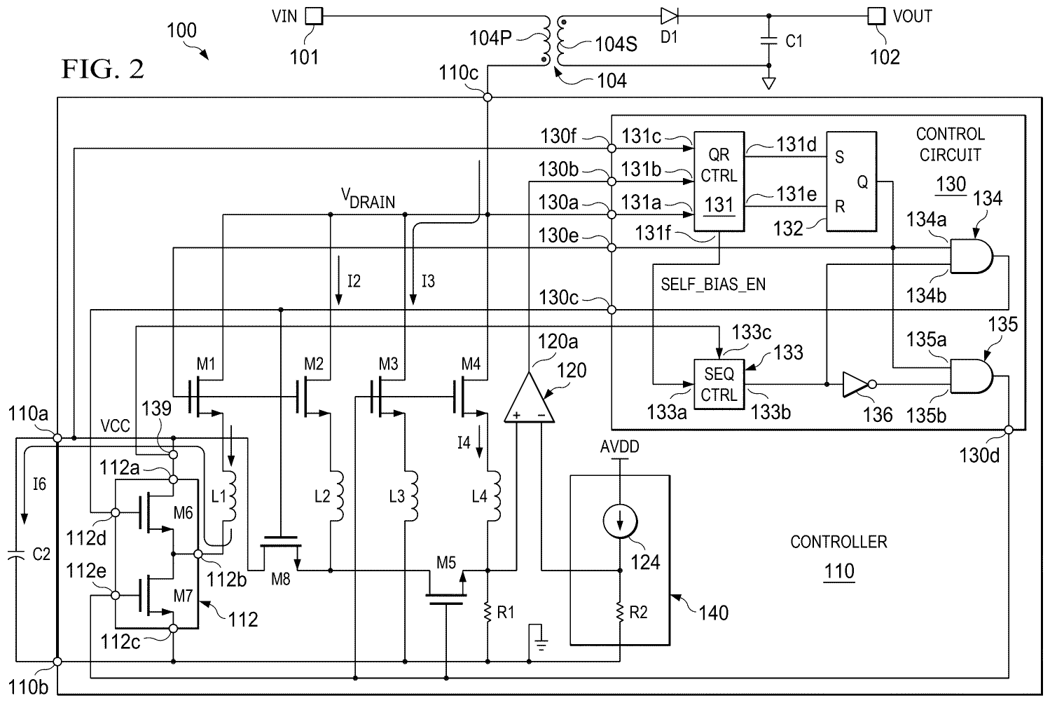

FIG. 1 is a schematic diagram of a power converter 100, in an example. In the example of FIG. 1, power converter 100 is a flyback converter, but the principles described herein apply to other types of power converters. Power converter 100 includes an input voltage terminal 101 and an output voltage terminal 102. Power converter 100 converts an input voltage (VIN) at the input voltage terminal 101 into an output voltage (VOUT) at the output voltage terminal 102. In this example, power converter 100 includes a transformer 104, a diode D1, capacitors C1 and C2, and a controller 110. Controller 110 has terminals 110a, 110b, and 110c. One terminal of capacitor C2 is coupled to terminal 110a and the opposing terminal of capacitor C2 is coupled to terminal 110b. Transformer 104 includes a primary coil 104P and a secondary coil 104S. The input voltage terminal 101 is coupled to one terminal of primary coil 104P. The opposing terminal of primary coil 104P is coupled to terminal 110c of controller 110. The anode of diode D1 is coupled to a terminal of the secondary coil 104S and the cathode of diode D1 is coupled to a terminal of capacitor C1 and to the output voltage terminal 102. The other terminal of capacitor C1 is coupled to the opposing terminal of the secondary coil 104S and to a ground terminal. The polarity of the primary and secondary coils 104P and 104S is indicated by the dots in FIG. 1.

Controller 110 includes transistors M1, M2, M3, M4, and M5, a diode D2, a switch circuit 112, a comparator 120, a control circuit 130, and a reference current circuit 140. Control circuit 130 has input terminals 130a, 130b, and 130f and outputs 130c, 130d, and 130e. Switch circuit 112 has switch circuit terminal 112a, 112b, and 112c. Switch circuit 112 includes transistors M6 and M8 (e.g., NFETs). In one example, transistors M1-M4 are high electron mobility transistors. As noted above, examples of high electron mobility transistors include gallium nitride (GaN) transistors, aluminum gallium nitride (AlGaN) transistors, indium phosphide (InP) transistors, silicon carbide (SiC) transistors, etc. Transistors M5-M7 are silicon transistors. Transistors M1-M7 are n-channel field effect transistors (NFETs) in the example of FIG. 1. In one example, transistors M1-M4 are fabricated on a first die, and transistor M5, diode D2, resistor R1, switch circuit 112, comparator 120, and reference current circuit 140 are fabricated on a second die. The first and second dies may be combined together in one module. In another example, the first and second dies are not combined into one module and are separate devices. Capacitor C2 may be external to the first and second dies in one example. In another example, capacitor C2 may be fabricated on one or the other of the first and second dies.

The drain of transistor M6 is coupled to switch circuit terminal 112a and to terminal 112d and to input 130f of control circuit 130. the source of transistor M6 is coupled to the drain of transistor M7 and to the source of transistor M1. Inductances L1, L2, L3, and L4 are parasitic inductances of the connections (e.g., bondwire connections) between the first and second dies mentioned above. The sources of transistors M7 and M3 are coupled together, to the terminal 110b, and the ground terminal. The gates of transistors M7, M3, M4, and M5 are coupled to output 130d of control circuit 130. The output 130c of control circuit 130 is coupled to the gate of transistor M6. The output 130e of control circuit 130 is coupled to the gates of transistors M1 and M2.

The cathode of diode Dd1 is coupled to terminal 112a of switch circuit 112, and the anode of diode D2 is coupled to the drain of transistor M5 and to the source of transistor M2. The source of transistor M5 is coupled to resistor R1, the source of transistor M4, and to a positive (+) input of comparator 120. Reference current circuit 140 includes a current source 124 coupled in series with a resistor R2 between a voltage terminal (AVDD) and the ground terminal. The connection between the current source 124 and resistor R2 is coupled to the negative (−) input of comparator 120.

Referring still to FIG. 1, control circuit 130 includes a quasi-resonant (QR) controller 131, a set-reset (SR) latch 132, a sequence controller 133, AND gates 134 and 135, and an inverter 136. QR controller 131 has inputs 131a, 131b, and 131c and outputs 131d, 131e, and 131f. Sequence controller 133 has input 133a and 133c and an output 133b. AND gate 134 has inputs 134a and 134b, and AND gate 135 has inputs 135a and 135b. Input terminals 130a, 130b, and 130f of control circuit 130 are coupled to inputs 131a, 131b, and 131c of QR controller 131, respectively. The outputs 131d and 131c of QR controller 131 are coupled to the set (S) and reset (R) inputs of SR latch 132. The Q output of SR latch 132 is coupled to inputs 134a and 135a of AND gates 134 and 135, respectively, and to the output 130c of control circuit 130. The output 131f of QR controller 131 is coupled to the input 133a of sequence controller 133, and the output 133b of sequence controller 133 is coupled to input 134b of AND gate 134 and to the input of inverter 136. The output of inverter 136 is coupled to the input 135b of AND gate 135. The outputs of AND gate 134 and 135 are coupled to outputs 130c and 130d of, respectively, of control circuit 130.

Transistor M3 is the main switching transistor for power converter 100. Transistor M4 functions as a sense transistor to sense the current through transistor M3. Transistor M4 is smaller than transistor M3 (e.g., 1000 times smaller). In the example of FIG. 1, controller 110 implements self-biasing which means that controller 110 generates a voltage VCC to power its active components using current from the primary coil 104P of transformer. Voltage VCC is the voltage to which capacitor C2 is charged, as described below. Internally generated voltage VCC may be provided to any or all of comparator 120, QR controller 131, SR latch 132, sequence controller 133, AND gates 134 and 135, and inverter 136. Transistor M1 may also be referred to as an auxiliary transistor and is usable in combination with switch circuit 112 to allow current to flow to capacitor C2 to thereby charge capacitor C2 to maintain voltage VCC at a target level. Transistor M2 senses the current through transistor M1. Transistor M2 is smaller than transistor M2 (e.g., 1000 times smaller).

With transistors M1-M4 on, current flows through primary coil 104P and energy is stored in transformer. As described below, transistors M1-M4 will be turned off by control circuit 130 when the current through the primary coil 104P exceeds a reference current. Voltage V_{DRAIN} is provided to the input terminal 130a of QR controller 131. With transistors M1, M2, M3, and M4 off, the voltage V_{DRAIN} on the drains of transistors M1-M4 increases. The secondary coil 104S will start conducting current due to energy stored in transformer 104. Current through the secondary coil 104P will flow to the output voltage terminal 102 and discharge the transformer. When the current in the secondary coil 104S also reaches zero, the voltage on V_{DRAIN} starts oscillating. QR controller 131 detects the minimum voltage of the voltage V_{DRAIN} during its oscillation and, at that time, generates a logic “1” at its output 131d to the S input of SR latch 132 thereby setting SR latch 132 and causing transistors M1 and M2 to turn on. Also, in response to V_{DRAIN} falling below the threshold level, based on the level of voltage VCC input 131c, QR controller 131 outputs a signal at a logic high or low level at its output 131f to sequence controller 133. If voltage VCC is above a threshold level to provide a sufficient bias voltage (VCC) to power the control circuit 130 and comparator 120, then QR controller 131 outputs a logic low signal at its output 131f to sequence controller 133. Otherwise, if voltage VCC is below the threshold level QR controller 131 outputs a logic high signal at its output 131f to sequence controller 133. A current sense circuit 139 coupled to transistor M6 provides a signal indicative of the current through transistor M6 to input 133c of sequence controller 133. Sequence controller 133 senses the current in transistor M6 and when the current through transistor M6 reaches a certain threshold, sequence controller 133 issues a logic low signal at its output 133b. The logic low at output 133b causes AND gate 134 to turn off transistor M6 and turn on the transistors M7, M5, M3, and M4.

With the Q output of SR latch being at a logic high level, a logic low signal from sequence controller 133 to input 134b of AND gate 134 and to inverter 136 causes the output signal from AND gate 134 to be logic low and the output signal from AND gate 135 to be logic high. With the output signals from AND gates 134 and 135 being logic low and high, respectively, transistor M6 in switch circuit 112 turns off and transistors M3 M4, M5, and M7 turn on. With transistor M6 off, current does not flow from the primary coil 104P to charge capacitor C2. Because voltage VCC is at a sufficient level, capacitor C2 does not need additional charging. With transistor M3 on, current I3 flows from the primary coil 104P through transistor M3. Further, current I4 flows through transistor M4 and, with transistor M2 on, a current I2 flows through transistor M2. Currents I2 and I4 combine to flow through resistor R1. A voltage is generated across resistor R1 which is proportional to the sum of current currents I2 and I4. A reference (e.g., fixed) current from current source 124 flows through resistor R2 and generates a fixed voltage across resistor R2. Comparator 120 compares the voltages across resistors R1 and R2. When the sum of currents I2 and I4 exceeds the reference current from current source 124, comparator 120 forces its output signal to a logic high level. The output signal from comparator 120 is provided to the input 131b of QR controller 131. QR controller 131 responds to a logic high assertion at its input 131b by forcing a signal at its output 131e to a logic high level thereby resetting SR latch 132. With SR latch 132 in a reset state, its Q output is a logic 0, the output of both AND gates 134 and 135 is logic low and transistors M-M7 are off.

In the state in which the voltage VCC is too low (e.g., below a threshold) and capacitor C2 needs to be charged, QR controller 131 generates a logic high at its output 131f and sequence controller 133 responds by providing a logic high signal level to the input 134b of AND 134 and to the input of inverter 136. A logic high signal level on the input of inverter 136 causes the input 135b of AND gate 135 to receive a logic low signal level. When voltage V_{DRAIN} begins oscillating as described above, QR controller 131 generates a logic “1” at its output 131d when the minimum voltage for oscillating voltage V_{DRAIN} occurs thereby setting SR latch 132. The output signal from AND gate 134 is logic high, and the output signal from AND gate 135 is logic low. With the Q output of SR latch 132 and the output of AND gate 134 being logic high and the output of AND gate 135 being logic low, transistors M1, M2, and M6 are on, and transistors M3-M5 and M7 are off. With transistors M1 and M6 on, current I16 flows from the primary coil 104P and through transistors M1 and M6 to charge capacitor C2. While capacitor C2 is charging, transistors M3 and M4 are off. In response to voltage VCC then rising above the threshold noted above, QR controller 131 responds by changing the logic state of the signal at its output 131f to a logic low. Sequence controller 133 responds to a logic low signal at its input 133a by forcing its output signal to a logic low level. With the Q output of SR latch 132 still at a logic high level, AND gates 134 and 135 force their output signals to logic low and high levels, respectively. Accordingly, transistor M6 turns off and transistors M3-M5 and M7 turn on. When the current through transistor M6 reaches a fixed threshold set by the sequence controller 133, transistors M1-M5 and M7 are turned off. Then, when the secondary coil 104P discharges, QR controller 133 detects the minima of the voltage V_{DRAIN} as described above, and the next switching cycle starts.

The technical advantage of the example power converter 100 illustrated in FIG. 1 is as follows. As described above, high electron mobility transistors, such as GaN transistors M1-M4 exhibit an aging phenomenon in response to repeatedly being switched on and off with relatively high Vds voltages. The aging phenomenon may manifest itself as an increase in the on-resistance of the transistor. The aging phenomenon may be particulate applicable to transistor M1. In one example, voltage VCC is approximately 6V and voltage V_{DRAIN} may be approximately 200V when transistor M1 is turned on. A Vds of 194V stresses transistor M1 and over time, the on-resistance of transistor M1 may increase.

As described above, transistor M1 is included to provide a self-biasing capability for power converter 100. However, transistor M1 influences the current sensing accuracy of transistor M4, which senses the current I3 through transistor M3. The sense ratio (SNSRatio) for transistor M4 for sensing the current through transistor M3 is:

$$SNSRatio = \frac{{R}_{SNS EFFECTIVE}}{{R}_{EFFECTIVE}} \qquad ( Eq . 1 )$$

Without transistor M2, R_{SNS EFFECTIVE} and R_{EFFECTIVE} are:

$${R}_{SNS EFFECTIVE} = R3\_SNS \_TOTAL + R 1 \qquad ( Eq . 2 )$$

$${R}_{EFFECTIVE} = R3\_TOTAL ‖ R1\_TOTAL \qquad ( Eq . 3 )$$

where the “∥” operator means the parallel combination of the resistors on either side of the operator and where:

$$R3\_SNS \_TOTAL = M4\_Rdson + R\_L4 \qquad ( Eq . 4 )$$

$$R3\_TOTAL = M3\_Rdson + R\_L3 \qquad ( Eq . 5 )$$

$$R1\_TOTAL = M1\_Rdson + R\_L1 + M7\_Rdson \qquad ( Eq . 6 )$$

and M1_Rdson, M4_Rdson, and M7_Rdson are the on-resistances of transistors M1, M4, and M7, respectively, and R_L1, R_L3, and R_L4 are the parasitic resistances associated with the connections between the sources of transistors M1, M3, and M4 and switch circuit terminal 112b, the anode of diode D2, and resistor R1, respectively. From equation Eq. 6 above, the value of R1_TOTAL is proportional to the on-resistance of transistor M1. Further, based on equation Eq. 3, R_{EFFECTIVE} is proportional to R1_TOTAL. Based on equation Eq. 1, the sense ratio SNSRATIO is inversely related to R_{EFFECTIVE}. Accordingly, as transistor M1 ages and its on-resistance M1_Rdson increases, the value of the sense ratio SNSRatio decreases thereby rendering the accuracy of the current sensing by transistor M4 and resistor R1 less accurate.

The drain of transistors M1 and M2 are connected together. The voltage on the source of transistor M2 is the forward bias voltage of diode D2 (approximately 0.6V) above the voltage on the source of transistor M1. Accordingly, by including transistor M2 with its gate and drain connected to the gate and drain, respectively, of transistor M1, and the voltage on the source of transistor M2 approximately equal to the voltage on the source of transistor M1, transistor M2 also experiences approximately the same aging phenomenon as transistor M1.

With transistor M2 in FIG. 1, equation Eq. 2 becomes:

$${R}_{SNS EFFECTIVE} = R3\_SNS \_TOTAL ‖ M2\_Rdson + R 1 \qquad ( Eq . 7 )$$

where M2_Rdson is the on-resistance of transistor M2. Accordingly, R_{SNS EFFECTIVE} is proportional to the on-resistance of transistor M2, which experiences elevated Vds-related again phenomenon, and R_{EFFECTIVE} is proportional to the on-resistance of transistor M1 (as explained above), which also experiences the elevated Vds-related again phenomenon. The numerator and denominator of the sense ratio in equation Eq. 1 are proportional to the on-resistances of transistors M2 and M1, respectively. Because both transistor M1 and M2 experience approximately the same change in their on-resistances as they are switching on and off together at elevated Vds voltages, the effects of changes in their on-resistances on the sense ratio approximately cancel each other thereby rendering the sense ratio substantially less susceptible to the aging phenomenon of transistors M1 and M2.

Diode D2 helps to ensure that the Vds across transistor M2 is approximately the same as the Vds across transistor M1 when transistors M1 and M2 are being turned on, thereby forcing approximately the same aging phenomenon on transistors M1 and M2. Other techniques can be employed to ensure the same or similar behavior. For example, FIG. 2 is a schematic of power converter that is generally the same as the schematic of FIG. 1, but transistor M8 has replaced diode D2. Transistor M8 is a silicon transistor (e.g., an NFET). The drain of transistor M8 is coupled to switch circuit terminal 112a, and the source of transistor M8 is coupled to the source of transistor M2 and the drain of transistor M5. The gate of transistor M8 is coupled to terminal 112d and to the gate of M6. Accordingly, transistor M8 is turned on and off commensurate with transistor M6 being turned on and off. When transistor M8 is on, the voltage on the source of transistor M2 is voltage VCC plus the small on-resistance of transistor M8. Accordingly, the Vds of transistor M2 is approximately the same as the Vds of transistors M1 when transistors M1 and M2 are turned on.

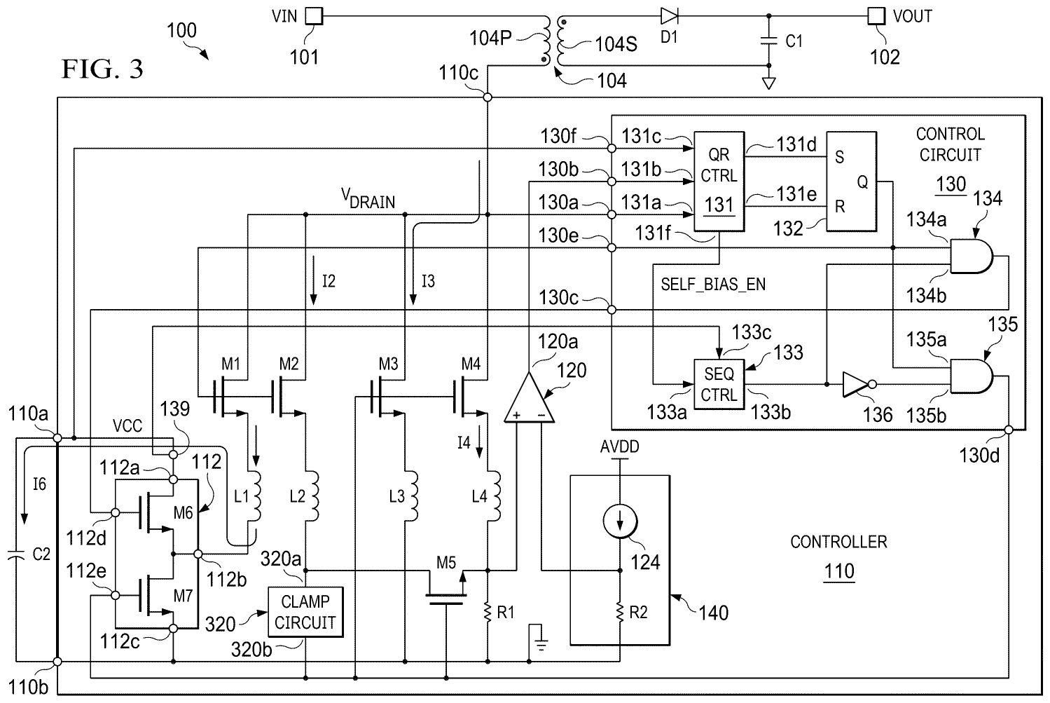

FIG. 3 is a schematic diagram of another example of power converter 10 that is generally the same as the schematics of FIGS. 1 and 2 but a clamp circuit 320 is included instead of diode D1 or transistor M8. The clamp circuit 320 has terminals 320a and 320b. terminal 320a is coupled to the source of transistor M2 and to the drain of transistor M5, and terminal 320b is coupled to the ground terminal. Clamp circuit 320 activates when the voltage difference between its terminals 320a and 320b reaches a clamp voltage (e.g., 200 mV) at which point clamp circuit 320 clamps the voltage between terminals 320a and 320b to the clamp voltage. When clamp circuit 320 activates, the voltage on the source of transistor M2 is voltage VCC plus the small clamp voltage (e.g., 200 mV) of clamp circuit 320. Accordingly, the Vds of transistor M2 is approximately the same as the Vds of transistors M1 when transistors M1 and M2 are turned on.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a p-channel field effect transistor may be used in place of any of the NFETs described herein. One or more of the transistors described herein may be implemented as a bipolar junction transistor. References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “on” or “enabled” means that the conduction channel of the FET is present and drain current may flow through the FET. References herein to a FET being “off” or “disabled” means that the conduction channel is not present so drain current does not flow through the FET. An “off” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. An apparatus, comprising:
a switch circuit having first and second terminals;
a first transistor having first and second terminals and a control terminal, the second terminal coupled to the second terminal of the switch circuit;
a second transistor having first and second terminals and a control terminal, the control terminals of the first and second transistors coupled together;
a third transistor having first and second terminals and a control terminal;
a fourth transistor having first and second terminals and a control terminal, the control terminals of the third and fourth transistors coupled together, and the first terminals of the first, second, third, and fourth transistors coupled together; and
a comparator having first and second comparator inputs, the first comparator input coupled to the second terminals of the second and fourth transistors.

2. The apparatus of claim 1, wherein the first, second, third and fourth transistors are high electron mobility transistors.

3. The apparatus of claim 1, wherein the first, second, third and fourth transistors are gallium nitride transistors.

4. The apparatus of claim 1, further comprising a diode having an anode and a cathode, the cathode coupled to the first terminal of the switch circuit and the anode coupled to the second terminal of the second transistor.

5. The apparatus of claim 1, further comprising a fifth transistor having first and second terminals and a control terminal, the first terminal of the fifth transistor coupled to the first terminal of the switch circuit and the second terminal of the fifth transistor coupled to the second terminal of the second transistor.

6. The apparatus of claim 1, further comprising a clamp circuit having a first terminal coupled to the second terminal of the second transistor and having a second terminal coupled to a ground terminal.

7. The apparatus of claim 1, wherein the comparator has an output, and the apparatus further comprises a control circuit having first and second inputs and first and second outputs, the first input of the control circuit coupled to the first terminals of the first, second, third, and fourth transistors, the second input of the control circuit coupled to the output of the comparator, the first output of the control circuit coupled to the control terminals of the first and second transistors, and the second output of the control circuit coupled to the control terminals of the third and fourth transistors.

8. The apparatus of claim 7, wherein the control circuit has a third output, and the switch circuit comprises:
a fifth transistor having a first terminal coupled to the first terminal of the switch circuit, having a second terminal coupled to the second terminal of the switch circuit, and having a control terminal coupled to the third output of the control circuit; and
a sixth transistor having a first terminal coupled to the second terminal of the switch circuit, having a second terminal coupled to the second terminal of the third transistor, and having a control terminal coupled to the second output of the control circuit.

9. The apparatus of claim 8, further comprising a seventh transistor having first and second terminals and a control terminal, the first terminal of the seventh transistor coupled to the second terminal of the second transistor, the second terminal of the seventh transistor coupled to the second terminal of the fourth transistor, and the control terminal of the seventh transistor coupled to the second output of the control circuit.

10. An apparatus, comprising:
a switch circuit having first and second switch terminals;
a first transistor having first and second terminals and a control terminal, the second terminal coupled to the second switch terminal of the switch circuit;
a second transistor having first and second terminals and a control terminal, the control terminals of the first and second transistors coupled together;
a third transistor having first and second terminals and a control terminal;
a fourth transistor having first and second terminals and a control terminal, the control terminals of the third and fourth transistors coupled together; and
a transformer having a primary coil and a secondary coil, the first terminals of the first, second, third, and fourth transistors coupled to the primary coil.

11. The apparatus of claim 10, further comprising:
a reference current circuit; and
a comparator having first and second comparator inputs, the first comparator input coupled to the second terminals of the second and fourth transistors, the second comparator input coupled to the reference current circuit.

12. The apparatus of claim 11, wherein the comparator has an output, the second terminal of the second transistor coupled to the first switch terminal, the switch circuit has first and second control terminals, and the apparatus further comprises:
a control circuit having a first and second inputs and first and second outputs, the first input of the control circuit coupled the output of the comparator, the second input of the control circuit coupled to the first terminals of the first, second, third and fourth transistors, the first output of the control circuit coupled to the first control terminal of the switch circuit, and the second output of the control circuit coupled to the control terminals of the third and fourth transistors and to the second control terminal of the switch circuit.

13. The apparatus of claim 10, wherein the first, second, third and fourth transistors are high electron mobility transistors.

14. The apparatus of claim 10, wherein the first, second, third and fourth transistors are gallium nitride transistors.

15. The apparatus of claim 10, further comprising at least one of a diode or fifth transistor coupled between the first switch terminal of the switch circuit and the second terminal of the second transistor.

16. The apparatus of claim 10, further comprising a clamp circuit having a first terminal coupled to the second terminal of the second transistor and having a second terminal coupled to a ground terminal.

17. An apparatus, comprising:
a switch circuit having a first and second control terminals and first and second switch terminals;
a first transistor having first and second terminals and a control terminal, the second terminal coupled to the second switch terminal of the switch circuit;
a second transistor having first and second terminals and a control terminal, the control terminals of the first and second transistors coupled together;
a third transistor having first and second terminals and a control terminal;
a fourth transistor having first and second terminals and a control terminal, the control terminals of the third and fourth transistors coupled together;
a comparator having first and second comparator inputs and an output, the first comparator input coupled to the second terminals of the second and fourth transistors; and
a control circuit having a first input, a second input, a first output, a second output, and a third output, the first input of the control circuit coupled the output of the comparator, the second input of the control circuit coupled to the first terminals of the first, second, third, and fourth transistors, the first output of the control circuit coupled to the first control terminal of the switch circuit, and the second output of the control circuit coupled to the control terminals of the third and fourth transistors and to the second control terminal of the switch circuit.

18. The apparatus of claim 17, wherein the apparatus has a capacitor terminal, and wherein the control circuit is configured to:
assert a first signal at the second output of the control circuit responsive to a signal at the output of the comparator to cause the third and fourth transistors to turn off; and
responsive to a signal on the first terminals of the first, second, third, and fourth transistors, assert a second signal at the third output of the control circuit to turn on the first and second transistors and, based on a voltage at the capacitor terminal, assert a third signal at the first output of the control circuit.

19. The apparatus of claim 17, wherein the first, second, third and fourth transistors are gallium nitride transistors.

20. The apparatus of claim 17, further comprising at least one of a diode or fifth transistor coupled between the first switch terminal of the switch circuit and the second terminal of the second transistor.
